(19) United States
(12) Patent Application Publication
(10) Pub. No.: US 2015/0156551 A1
(43) Pub. Date: Jun. 4, 2015

(54) ELECTRONIC DEVICE, IMAGE DISPLAY METHOD FOR USE IN THE ELECTRONIC DEVICE AND STORAGE MEDIUM FOR IMAGE DISPLAY PROGRAM

(71) Applicants: Kabushiki Kaisha Toshiba, Tokyo (JP); Toshiba Lifestyle Products & Services Corporation, Tokyo (JP)

(72) Inventor: Emi Maruyama, Tokyo (JP)

(21) Appl. No.: 14/469,342

(22) Filed: Aug. 26, 2014

(30) Foreign Application Priority Data
Nov. 29, 2013 (JP) 2013-248155

(51) Int. Cl. H04N 21/4782; H04N 21/435; H04N 21/41

(52) U.S. Cl. CPC H04N 21/4782; H04N 21/4122; H04N 21/4355

(57) ABSTRACT

According to one embodiment, in an electronic device communicable with a first electronic device, when the electronic device has received a first instruction to display a second image different from a first image in a state in which it displays the first image, it supplies the first electronic device with a second instruction to instruct the same to display the second image, using the first instruction. The first electronic device uses the second instruction to display the second image via a web browser using web information received from a server.

### CROSS-REFERENCE TO RELATED APPLICATIONS

This application is based upon and claims the benefit of priority from Japanese Patent Application No. 2013-248155, filed Nov. 29, 2013, the entire contents of which are incorporated herein by reference.

### FIELD

Embodiments described herein relate generally to an electronic device, an image display method for use in the electronic device, and a storage medium for an image display program.

### BACKGROUND

For instance, in digital televisions, when an electronic program guide (EPG) is displayed as a sub-image, with digital broadcasting program content displayed as a main image, overlay display is generally employed. In the overlay display, the sub-image is displayed to overlap with the main image currently viewed. Further, when data broadcasting content is displayed as a sub-image, screen separation display is generally performed. In the screen separation display, for example, a main image is contracted and a sub-image is displayed on the margin. In any case, the sub-image is displayed by sacrificing the display of the main image. There is a demand for a technique of displaying a sub-image without sacrificing the display of a main image.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic block diagram showing the configuration of an electronic system according to an embodiment;

FIG. 2 is a schematic block diagram showing a web-enabled digital television (TV) as an electronic device according to the embodiment;

FIG. 3 is a block diagram showing the state of connection between a main TV and a sub-TV incorporated in the electronic system according to the embodiment;

FIG. 4 is a flowchart employed in the embodiment for performing control of displaying a main image on a main TV and a sub-image on a sub-TV;

FIG. 5 shows an example (EPG) of a display of a main image on the main TV and sub-information on the sub-TV; and

FIG. 6 is another example of a display of a main image on the main TV and sub-information (weather forecast) on the sub-TV. according to the embodiment.

### DETAILED DESCRIPTION

Various embodiments will be described hereinafter with reference to the accompanying drawings. In general, according to one embodiment of the invention, an electronic device configured to communicate with a first electronic device, comprising: a display controller configured to display a first image; and a processor configured to supply, if a first instruction is received during the display controller displaying the first image, the first electronic device with a second instruction for displaying a second image different from the first image at the first electronic device, the second instruction generated by using the first instruction. The second instruction is used by the first electronic device to display the second image by a web browser using web information received from a server.

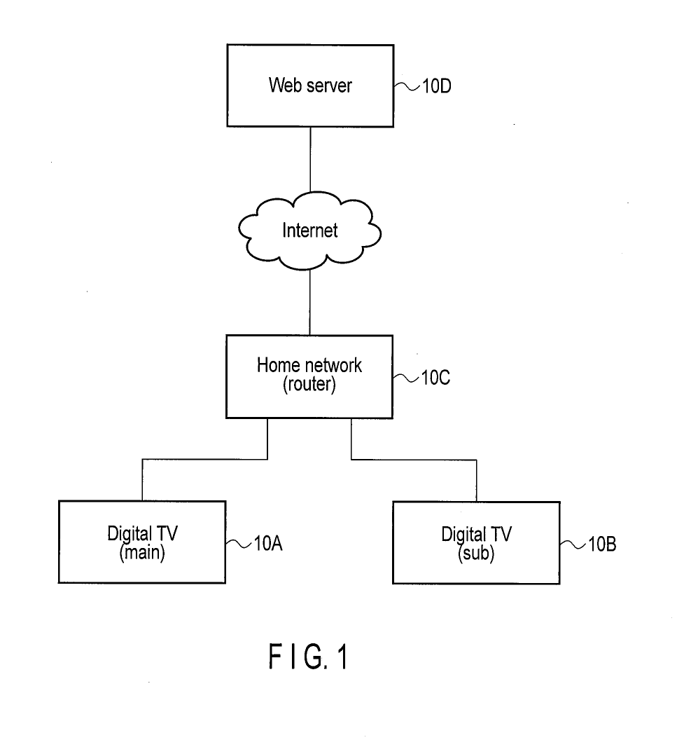

FIG. 1 is a block diagram showing the configuration of an electronic system according to an embodiment. In FIG. 1, reference number 10A denotes a digital TV regarded as a main TV for a descriptive purpose, reference number 10B denotes a digital TV regarded as a sub-TV for a descriptive purpose, reference number 10C denotes a home network, and reference number 10D denotes a web server. One or more sub-TVs 10B may be employed.

The digital TVs 10A and 10B connected to the home network 100 have a function of enabling themselves to be connected to the web server 10D on the Internet. The digital TVs 10A and 10B can transmit and receive various control commands to and from each other through the home network 100. The digital TVs 10A and 10B are web-enabled ones that contain web browsers, and have a function of acquiring, for example, HTML content from the web server 10D on the Internet through the HTTP (or HTTPS) protocol, and displaying the acquired content on the screen.

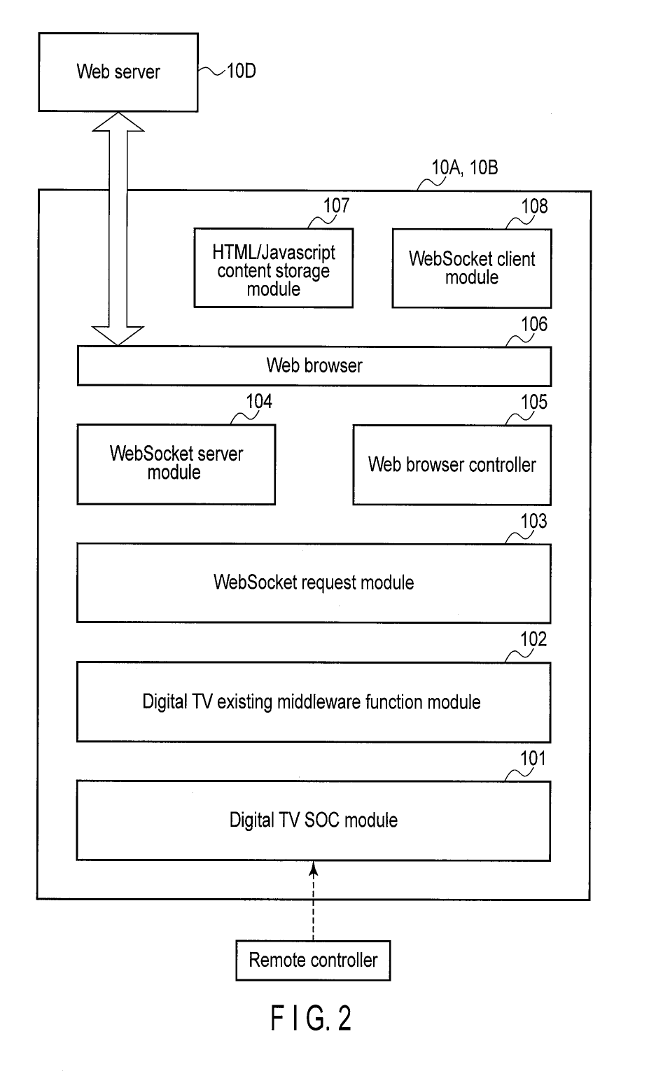

FIG. 2 shows the function structure of each of the web-enabled digital TVs 10A and 10B according to the embodiment. In FIG. 2, reference number 101 denotes a digital-TV System-On-Chip (SOC) module configured to execute digital-TV basic processing, reference number 102 denotes a middleware function module configured to execute digital-TV expanded processing, reference number 103 denotes a WebSocket request processing module, reference number 104 denotes a WebSocket server module, 105 denotes a web browser controller, reference number 106 denotes a web browser, reference number 107 denotes a HTML/Japascript (trademark) content storing module, and reference number 108 denotes a WebSocket client module.

The “WebSocket” means a communication protocol standardized by the Internet Engineering Task Force (IETF), which is a function, based on HTTP, of enabling the digital TV to transmit and receive a text character string to and from a destination device connected to the TV. Compared to HTTP, WebSocket is advantageous in performing request/response at very high speed. The WebSocket request processing module 103 has a function of receiving a user's WebSocket communication request and transmitting the same to a destination device. The WebSocket server module 104 and the WebSocket client module 108 can exhibit a server function and a client function for WebSocket communication, respectively, if IP addresses are beforehand registered between these modules and a destination device.

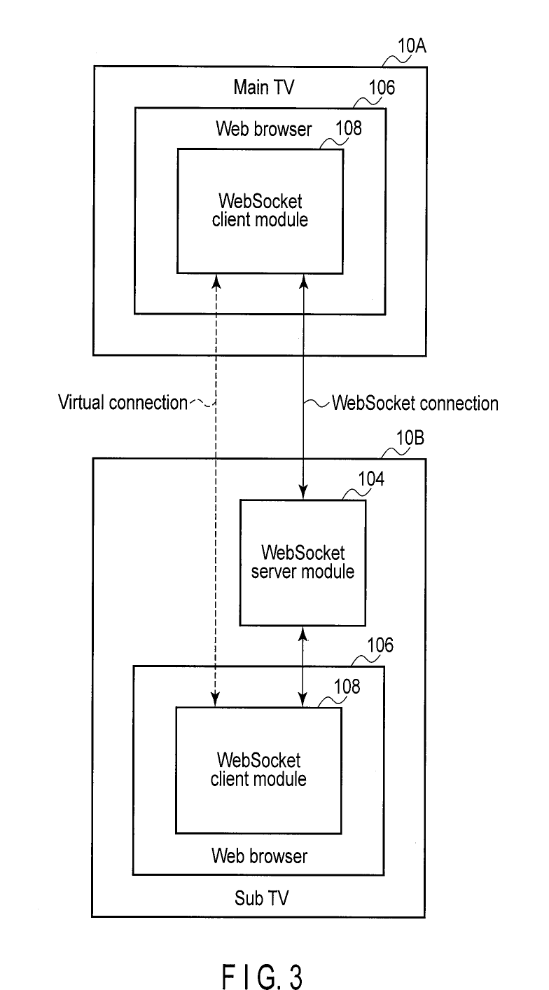

Referring now to FIG. 3, a description will be given of the outline of the above-mentioned WebSocket communication. FIG. 3 shows a case where the sub digital TV 10B is controlled by the main digital TV 10A. Further, the WebSocket client function operates on the web browser 106.

The WebSocket communication can be performed between the WebSocket client module and the WebSocket client of another digital TV, and can be utilized as a virtual connection between the WebSocket clients. This enables free communication between applications, as well as the use of the digital TV functions. The transmission and reception of control commands described with reference to FIG. 1 correspond to the virtual connection shown in FIG. 3.

In FIG. 2, the WebSocket request processing module 103 processes a received WebSocket request. More specifically, the WebSocket request processing module 103 discriminates a user's request and appropriately instructs the web browser controller 105 or the middleware function module 102 to process the request. For instance, if there is a request to “open a designated URL through the web browser 106,” the WebSocket request processing module 103 instructs the web browser controller 105 to process the request. If there is a request to “adjust (+10) the volume,” it instructs the middleware function module 102 to process the request.

The web browser 106 can display the content (LocalGUI) stored in the HTML/Japascript (trademark) content storing module in the digital TV, as well as the content acquired from the web server 10D.

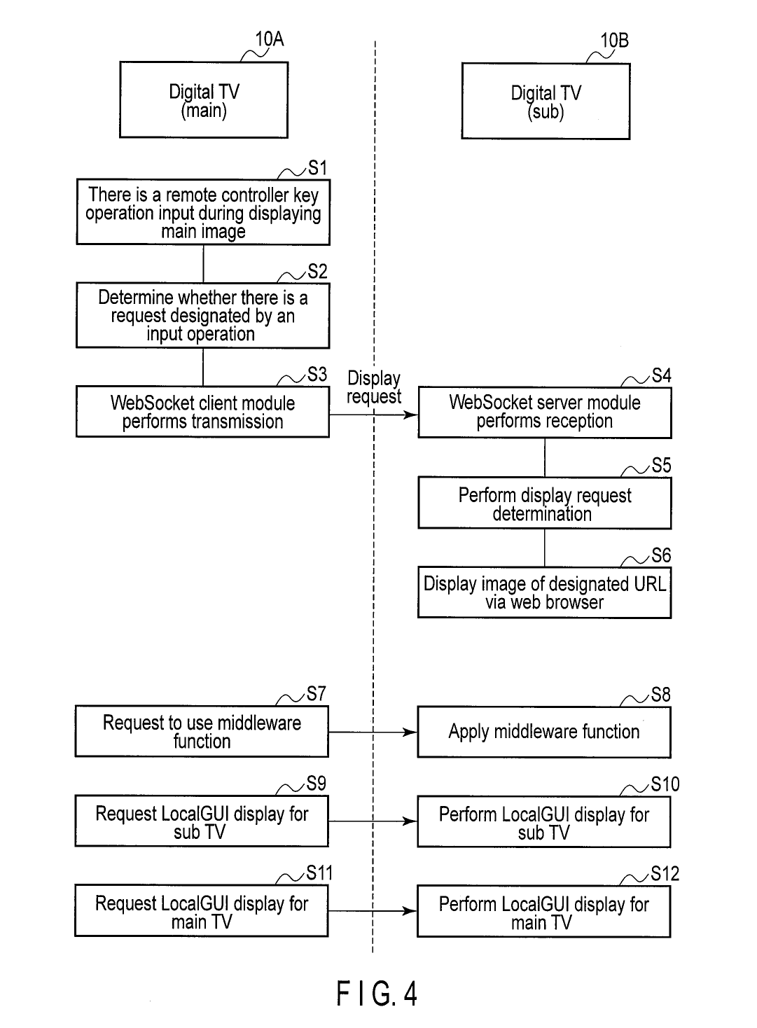

Referring then to the sequence view of FIG. 4, the flow of processing of the electronic system of the embodiment will be described.

Firstly, when the main image (first image) is displayed on the main digital TV 10A, if there is an operation input (a first instruction) from a remote controller (S1), the request designated by the input operation is discriminated (S2), and the WebSocket client module 108 reports the request (a second instruction) to the WebSocket server module 104 of the sub digital TV 10B (S3).

In the sub digital TV 10B, upon receiving the request from the WebSocket client module 108 of the main digital TV 10A, the WebSocket server module 104 reports the request to the WebSocket request processing module 103 (S4). If the request is, for example, a request to display a program guide on the web browser using a program information button, a request to display web server content using a cloud button, or a request to display the HTML/Japascript content of the sub digital TV 10B using, for example, a menu button (S5), the WebSocket request processing module 103 responds to the request by opening the designated URL through the web browser 106 (S6).

When the request utilizes the middleware function (S7), a function corresponding to the middleware function module 102 is executed (S8). Further, if the request is to perform LocalGUI display of the HTML/Japascript content stored in the HTML/Japascript content storing module 107 of the sub digital TV (S9), the web browser controller 105 of the sub digital TV is made to execute LocalGUI display of the designated content (S10). Yet further, if the request is to perform LocalGUI display of the HTML/Japascript content in the main digital TV (S11), the WebSocket client module 108 of the main digital TV transmits, to the sub digital TV, the reference URL corresponding to the content stored in the HTML/Japascript content storing module 107 of the main digital TV, thereby causing the web browser controller 105 of the sub digital TV to display the designated content (S12).

If the same request has been repeatedly input, it is assumed that only the first-input request should be responded. Namely, when a current request to display a sub image has been issued to the sub digital TV in a state in which a main image is displayed on the main digital TV, after a preceding request to display a sub image is issued to the sub digital TV, the processing requested by the current request is not performed if the sub image requested by the current request is the same as that requested by the preceding request and currently displayed on the sub digital TV.

However, when a current request to display a sub image has been issued to the sub digital TV in a state in which a main image is displayed on the main digital TV, after a preceding request to display a sub image is issued to the sub digital TV, the processing requested by the current request is performed even if the sub image requested by the current request is the same as that requested by the preceding request, if the display of the sub image requested by the preceding request is already finished.

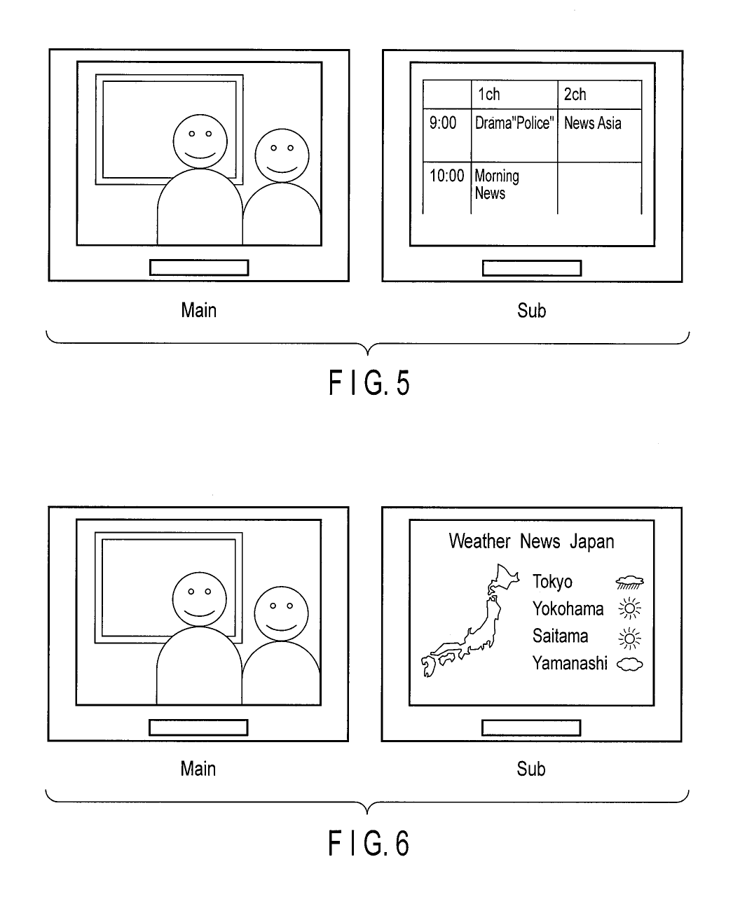

FIGS. 5 and 6 show images in the embodiment.

When a user has pressed a program information button on the remote controller of the main digital TV 10A to request to display program information while a certain program is displayed on the main digital TV 10A, a program information display application, for example, employed in the sub digital TV 10B is activated to thereby display program information on the sub digital TV 10B, as is shown in FIG. 5.

Further, when the user has pressed a cloud button on the remote controller of the main digital TV 10A to request to display weather information on the web server 10D while a certain program is displayed on the main digital TV 10A, the designated weather information on the web server 10D is acquired by the sub digital TV 10B and displayed thereon, as is shown in FIG. 6.

Yet further, when a certain program is displayed on the main digital TV 10A, after the user presses the program information button on the remote controller of the main digital TV 10A to request to display program information on the sub digital TV 10B, the sub digital TV 10B is made to be able to receive a remote control signal and the main digital TV 10A is made to be unable to receive the same. In this state, when recording of a TV program is designated by the remote controller, the TV program is selected and its recording is programmed on the program guide of the sub digital TV 10B. Alternatively, after this selection is performed in the sub digital TV 10B, the record programming information may be reported to the main digital TV 10A and recorded therein.

This exclusive control of the remote control signal is determined based on the number of sub TVs connected to the main TV and the remote control operation. Although the embodiment employs one main TV and one sub TV, it may be modified to employ, for example, one main TV and two sub TVs. In this case, the system can be designed, for example, such that when the electronic program information button of the remote controller has been pressed during viewing the main TV, one of the sub TVs displays the electronic program information, and when the cloud button of the remote controller has been pressed, the other sub TV displays content on the web server.

As described above, in the structure of the embodiment, images do not overlap each other, and therefore, the user can see a program guide while viewing a program, or can see a cloud service while viewing a program. This is very convenient to the user.

In addition, after a request to display a first sub image is issued to the sub TV, if a request to display a second sub image different from the first sub image has been issued, processing of displaying the first sub image on the main or sub TV, and processing of displaying the second sub image on the main or sub TV are performed. As a result, a plurality of sub images other than main images can be selectively displayed on the main and sub TVs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device configured to communicate with a first electronic device, comprising:
a display controller configured to display a first image; and
a processor configured to supply, if a first instruction is received during the display controller displaying the first image, the first electronic device with a second instruction for displaying a second image different from the first image at the first electronic device, the second instruction generated by using the first instruction,
wherein the second instruction is used by the first electronic device to display the second image by a web browser using web information received from a server.

2. The electronic device of claim 1, wherein
the server is a second electronic device;
each of the electronic device, the first electronic device and the second electronic device is configured to display an image; and
the second instruction is used by the first electronic device to display the second image via the web browser using web information stored in the second electronic device.

3. The electronic device of claim 1, wherein when the electronic device receives a third instruction to display the second image while the second image is displayed on the first electronic device, after sending the second instruction to the first electronic device, the processor does not perform processing based on the third instruction.

4. The electronic device of claim 1, wherein when the electronic device receives a third instruction to display the second image while the second image is not displayed on the first electronic device, after sending the second instruction to the first electronic device, the processor supplies the first electronic device with a fourth instruction to display the second image.

5. The electronic device of claim 1, wherein when the electronic device receives a fifth instruction to display a third image different from the first and second images after sending the second instruction to the first electronic device, the processor performs processing of displaying the second image on the electronic device or the first electronic device, and processing of the third image on the electronic device or the first electronic device.

6. An image display method for use in an electronic device configured to communicate with a first electronic device, comprising:
supplying, if a first instruction is received during the display controller displaying the first image, the first electronic device with a second instruction for displaying a second image different from a first image at the first electronic device, the second instruction generated by the first instruction,
wherein the second instruction is used by the first electronic device to display the second image by a web browser using web information received from a server.

7. The image display method of claim 6, wherein
the server is a second electronic device;
each of the electronic device, the first electronic device and the second electronic device can display an image; and
the second instruction is used by the first electronic device to display the second image via the web browser using web information stored in the second electronic device.

8. The image display method of claim 6, wherein when the electronic device receives a third instruction to display the second image while the second image is displayed on the first electronic device after the second instruction is sent to the first electronic device, processing based on the third instruction is not performed.

9. The image display method of claim 6, wherein when the electronic device receives a third instruction to display the second image while the second image is not displayed on the first electronic device after the second instruction is sent to the first electronic device, the first electronic device is supplied with a fourth instruction to display the second image.

10. The image display method of claim 6, wherein when the electronic device receives a first instruction to display a third image different from the first and second images after the second instruction is sent to the first electronic device, processing of displaying the second image on the electronic device or the first electronic device, and processing of the third image on the electronic device or the first electronic device are performed.

11. A computer-readable recording medium including instructions executed by a computer for use in an electronic device communicable with a first electronic device, wherein the instructions, when executed by the computer, cause the computer to perform an image display method comprising:
determining whether a first instruction to display a second image different from a first image is received by the electronic device, in a state in which the first image is displayed by the first electronic device;
supplying, if a first instruction is received during the display controller displaying the first image, the first electronic device with a second instruction for displaying a second image different from the first image at the first electronic device, the second instruction generated by using the first instruction,
wherein the second instruction is used by the first electronic device to display the second image by a web browser using web information received from a server.

12. The computer-readable recording medium of claim 11, wherein
the server is a second electronic device;
each of the electronic device, the first electronic device and the second electronic device can display an image; and
the second instruction is used by the first electronic device to display the second image via the web browser using web information stored in the second electronic device.

13. The computer-readable recording medium of claim 11, wherein the image display method comprising further comprises determining whether a third instruction to display the second image has been received by the electronic device while the second image is displayed on the first electronic device after sending the second instruction to the first electronic device, the processor does not perform processing based on the third instruction,
wherein when the electronic device receives the third instruction, processing based on the third instruction is not performed.

14. The computer-readable recording medium of claim 11, wherein the image display method comprising further comprises:
determining whether the electronic device receives a third instruction to display the second image while the second image is not displayed on the first electronic device after sending the second instruction to the first electronic device; and
supplying the first electronic device with a fourth instruction to display the second image when the electronic device receives the third instruction.

15. The computer-readable recording medium of claim 11, wherein the image display method comprising further comprises:
displaying the second image on the electronic device or the first electronic device when the electronic device receives a first instruction to display a third image different from the first and second images after sending the second instruction to the first electronic device;
displaying the third image on the electronic device or the first electronic device.
